(19) United States
(12) Patent Application Publication
(10) Pub. No.: US 2007/0085923 A1
(43) Pub. Date: Apr. 19, 2007

(54) Solid-state imaging apparatus

(75) Inventor: Shunsuke Suzuki, Miyagi (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/541,586

(22) Filed: Oct. 3, 2006

(30) Foreign Application Priority Data
Oct. 4, 2005 (JP) P2005-291123

(51) Int. Cl. H04N 5/335

(52) U.S. Cl. 348/312

(57) ABSTRACT

A solid-state imaging apparatus includes a solid-state imaging device and an image data generating section that generates image data from an image signal outputted from the solid-state imaging device. In an operation mode to successively outputting image signals from the solid-state imaging device and in a case performed a long-time exposure wherein an exposure period for obtaining a second image signal next to the first image signal continues a predetermined time even after a completion of outputting of a first image signal from the solid-state imaging device, a signal-processing-unit-operation control section performs control of providing a period for which the image data generating section is suspended from operating in a duration of from a completion of signal processing on the first image signal up to a time for starting a signal processing on the second image signal.

### BACKGROUND OF THE INVENTION

1. Field of the Invention

The present invention relates to a solid-state imaging apparatus having a solid-state imaging device and an image-data generating section that generates image data from an image signal outputted from the solid-state imaging device.

2. Description of the Related Art

In the related art, there is disclosed an imaging apparatus capable of reducing the consumption power by a simple method (see JP-A-2002-369082, for example).

This related art realizes the reduction of consumption power by regulating the timing of charge transfer to the vertical and horizontal CCDs (charge coupled devices). The related art regulates the drive timing to the vertical and horizontal transfer sections during the operation other than outputting an image signal from the CCD solid-state imaging devices, e.g. during charge storage such as in exposure period, thereby reducing the consumption power. The vertical CCDs are not operated in the exposure period but caused for high-speed transfer after the exposure period, thereby transferring the excessive portion of charge onto the horizontal CCD section. As for the horizontal CCD, provided are three methods concerning timing to sweep out the unwanted portion of charge, as follows:

1. method of suspending the horizontal transfer section at a constant interval in exposure period so that transfer and suspension can be repeated at a regular interval,

2. method of suspending the horizontal transfer section at a random interval in exposure period so that transfer and suspension can be repeated at an irregular interval, and

3. method of suspending the driving to the horizontal transfer section in exposure period so that the horizontal transfer section can be driven only immediately before reading the charge onto the CCD from a photodiode lapsed the exposure period.

The timing of generations are controlled by the timing generator, under the control of a system controller.

However, the related art methods are to reduce the consumption power by merely regulating the timing to drive the imaging device in the exposure period. The sections, for processing the image signal outputted from the solid-state imaging device, are left operating to consume power uselessly.

### SUMMARY OF THE INVENTION

The present invention has been made in view of the circumstances, and it is an object thereof to provide a solid-state imaging apparatus capable of reducing the consumption power.

A solid-state imaging apparatus in the present invention comprises: (i) a solid-state imaging device comprising: a plurality of photoelectric conversion elements; a vertical transfer section that vertically transfers a signal charge stored on the photoelectric conversion elements; a horizontal transfer section that horizontally transfers the signal charge transferred the vertical transfer section; and an output amplifier that outputs an image signal commensurate with the signal charge transferred the horizontal transfer section; and (ii) an image-data generating section that generates image data from the image signal, wherein the image-data generating section comprises a plurality of signal processing units that perform different signal processes, in order, on the image signal, and wherein the solid-state imaging apparatus further comprises a signal-processing-unit-operation control section that, in an operation mode to successively outputting image signals from the solid-state imaging device and in a case performed a long-time exposure wherein an exposure period for obtaining a second image signal next to a first image signal continues a predetermined time even after a completion of outputting of the first image signal from the solid-state imaging device, performs control of providing a period for which at least one of said plurality of signal processing units is suspended from operating in a duration of from a completion of signal processing on the first image signal up to a time for starting a signal processing on the second image signal.

According to the invention, there is provided the solid-state imaging apparatus further comprising a transfer control section that, in the long-time exposure, performs control of providing a period for which the vertical and horizontal transfer sections are suspended from transfer-operating in a duration of from a completion of outputting the first image signal from the output amplifier up to a termination of an exposure period for obtaining the second image signal.

### BRIEF DESCRIPTION OF THE DRAWINGS

FIG. 1 is a block diagram showing a schematic configuration of a solid-state imaging apparatus in an embodiment;

FIG. 2 is a diagram showing a schematic configuration of a solid-state imaging device shown in FIG. 1;

FIG. 3 is a block diagram showing a schematic configuration of a digital signal processor shown in FIG. 1;

FIG. 4 is a timing chart showing an operation of the solid-state imaging apparatus in the present embodiment, when displaying a through image or taking a moving image; and

FIG. 5 is a timing chart showing an operation of the solid-state imaging apparatus in the present embodiment, in the case of performing a long-time exposure during displaying a through image or taking a moving image.

### DETAILED DESCRIPTION OF THE INVENTION

In the following, there is shown an embodiment of a solid-state imaging apparatus according to the present invention. The image signal used in explaining the embodiment means a form not to be displayed by itself while image data a form to be displayed by itself.

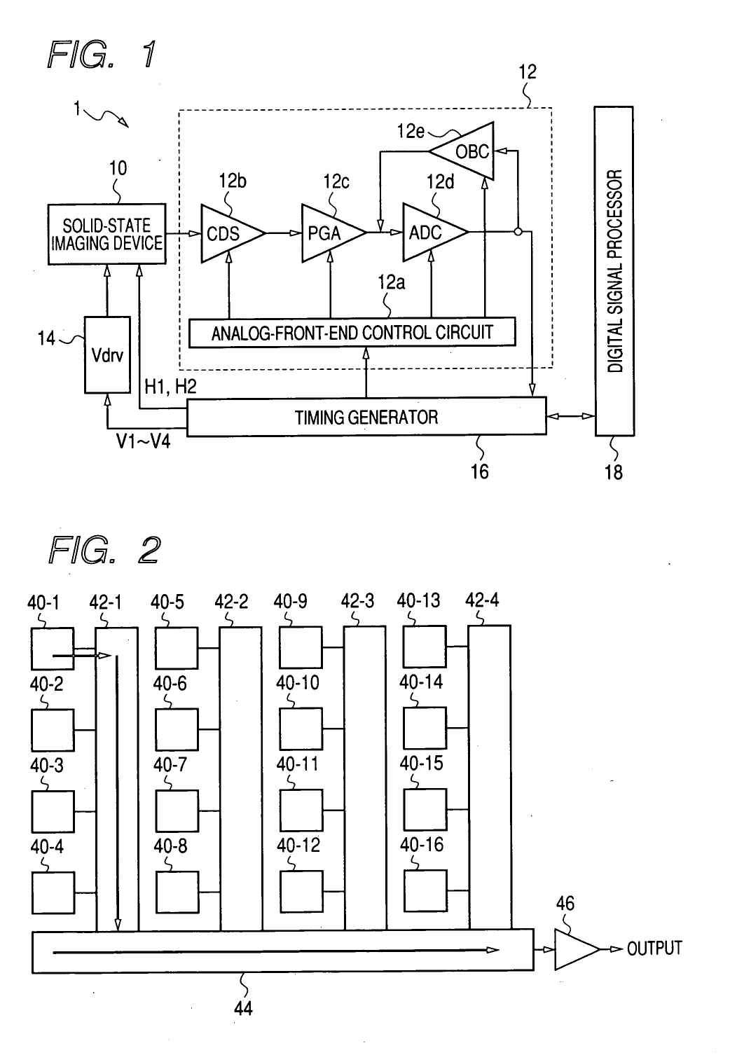

FIG. 1 is a block diagram showing a schematic configuration of a solid-state imaging apparatus in the present embodiment.

A solid-state imaging apparatus 1, shown in FIG. 1, is constructed with a solid-state imaging device 10, an analog front end (AFE) 12, a vertical CCD transfer pulse driver 14, a timing generator 16 and a digital signal processor (DSP) 18. The analog front end 12 is under control of the digital signal processor 18 through the timing generator 16. The analog front end 12 and the digital signal processor 18 constitute an image-data generating section in the claims.

The analog front end 12 has an analog-font-end control circuit 12a to operate on a drive signal of from the timing generator 16, a correlated-double sampling (CDS) circuit 12b, a programmable-gain amplifier (PGA) circuit 12c, an analog-to-digital converter (ADC) circuit 12d and an optical-black-level clamp (OBC) circuit 12e. The analog-font-end control circuit 12a is to operate on an analog-front-end drive signal received from the timing generator 16 and takes drive control of the elementary circuits of the analog front end 12.

The solid-state imaging device 10 outputs an image signal to be inputted to the correlated-double sampling circuit 12b where removed of noise. The correlated-double sampling circuit 12b has an output signal to be inputted to the amplifier circuit 12c where adjusted in level. The amplifier circuit 12c has an output signal to be inputted to the analog-to-digital converter circuit 12d where converted into a digital signal. The analog-to-digital converter circuit 12d has an output signal to be inputted to the optical-black-level clamp circuit 12e where corrected for black level. The optical-black-level clamp circuit 12e has an output signal to be fad back to the analog-to-digital converter circuit 12d so that an image signal can be finally outputted in a desired level from the analog-to-digital converter circuit 12d. The image signal, outputted from the analog-to-digital converter circuit 12d, is inputted to the timing generator 16. The image signal is inputted through the timing generator 16 to the digital signal processor 18 where converted into image data.

FIG. 2 is a diagram showing a schematic configuration of the solid-state imaging device shown in FIG. 1.

The solid-state imaging device 10 is the related-art CCD solid-state imaging device. This includes a multiplicity of photoelectric converter elements 40-1, 40-2, . . . , 40-n (n: natural number), vertical transfer sections 42-1, 42-2, 42-n to transfer vertically (in a direction from above to below, in the figure) the signal charge stored on the photoelectric converter elements 40-1, 40-2, . . . , 40-n, a horizontal transfer section 44 to transfer horizontally (in a direction from left to right, in the figure) the signal charge transferred by the vertical transfer sections 42-1, 42-2, . . . , 42-n, and an output amplifier 46 to output a image signal commensurate with the signal charge transferred by the horizontal transfer section 44.

A transfer gate pulse (TG) supplied from the timing generator 16 reads out the charge stored on the photoelectric converter element 40 such as a photodiode in a direction shown with a horizontal bold arrow drawn from left to right of the photoelectric converter element 40.

The charges, read out of the photoelectric converter elements 40-1, 40-2, . . . , 40-n, are transferred in a direction shown with the vertical bold arrows drawn from above to below by the vertical transfer sections 42-1, 42-2, . . . , 42-n. Then, the charges transferred through the vertical transfer sections 42-1, 42-2, . . . , 42-n are sequentially transferred through the horizontal transfer section 44 and amplified by the output amplifier 46, thus being outputted as an image signal.

In an operation mode to successively output image signals from the solid-state imaging device 10, e.g. upon displaying through images or taking a moving image, the solid-state imaging apparatus, if exposure period is taken constant, operates as in the following. Namely, as soon as an image signal has been completely outputted in an amount of a first frame out of the solid-state imaging device 10, charge transfer is already started correspondingly to an image signal in an amount of a second frame following the first frame. As soon as the AFE 12 completes a signal processing of the first frame of image signal, the AFE 12 starts a signal processing of the second frame of image signal. As soon as the digital signal processor 18 completes a signal processing of the first frame of image signal, the digital signal processor 18 starts a signal processing of the second frame of image signal. Namely, in usually displaying a through image or taking a moving image, operation continues nearly uninterruptedly in the solid-state imaging device 10, the AFE 12 and the digital signal processor 18 unless the through-image display or moving-image taking completes.

However, where performing such a long-time exposure that exposure period continues a predetermined time for the next second frame of image signal after completing an exposure period for the first frame of image signal, e.g. where performing a still or moving image taking in an exposure period longer than the exposure period for displaying a through image (e.g. twice of exposure time) from displaying a through image or where the exposure period is increased (e.g. twice exposure time) by an insufficient amount of light during taking a moving image, there exists a period in which the solid-state imaging device 10, the AFE 12 and the digital signal processor 18 must not be operated.

Therefore, the solid-state imaging apparatus 1 in the present embodiment is to reduce the consumption power by taking control of suspending the sections operating from operating uselessly in the case performing a long-time exposure. Such control is to be effected by the timing generator 16 and a clock control 34c, referred later. The timing generator 16 corresponds to a transfer control section in the claims. The timing generator 16 and clock control section 34c constitutes a signal-processing-unit operation control section in the claims.

In the case a long-time exposure is done, exposure continues to acquire a second image signal, that is an image signal obtained due to the long-time exposure, when output is completed of a first image signal that is an image signal obtained by an exposure immediately preceding the long-time exposure. In the first period of from a completion of outputting the first image signal from the solid-state imaging device 10 up to a termination of the long-time exposure, it is not problematic to suspend the operation of the vertical transfer sections 42-1, 42-2, . . . , 42-n and horizontal transfer section 44.

Accordingly, the timing generator 16, in the first period, suspends the supply of a drive pulse to the vertical transfer sections 42-1, 42-2, . . . , 42-n and horizontal transfer section 44, thus effecting control to suspend the vertical and horizontal transfer sections from operating. This makes it possible to reduce the consumption power. Incidentally, the timing generator 16 is not required to suspend the vertical and horizontal transfer sections from operating over the entire first period. It is satisfactory, in the duration, to perform a drive-pulse control in a manner allowing at least a period to exist suspending the vertical and horizontal transfer sections from operating.

Meanwhile, in the case a long-time exposure is done, the AFE 12 can be suspended, without any problem, in a second period, of from a time the AFE 12 completes the signal processing of the first image signal up to a time the AFE 12 is allowed to start a signal processing of the second image signal. For this reason, the timing generator 16 in the second period suspends the supply of a drive pulse to the AFE 12, thus effecting control to suspend the AFE 12 from operating. Incidentally, the timing generator 16 must not suspend the AFE 12 from operating over the entire second period. It is satisfactory to control a drive pulse, to be supplied to the AFE 12, in a manner giving at least a period to suspend the AFE 12 from operating in the period.

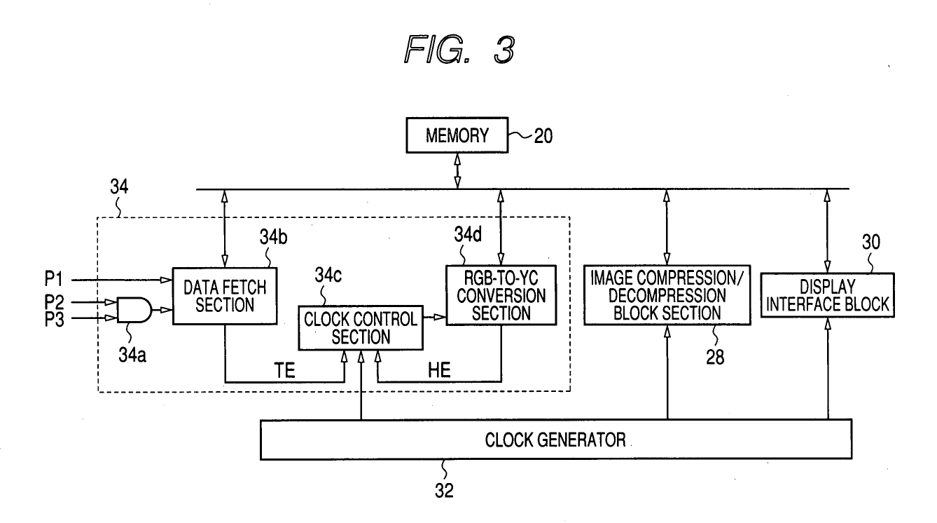

FIG. 3 is a block diagram showing a schematic configuration of the digital signal processor shown in FIG. 1.

As shown in FIG. 3, the digital signal processor 18 includes a memory 20, an image processing section 34, an image-compression/decompression block section 28, a display-interface block 30 and a clock generator 32.

The image processing section 34 includes a logic gate 34a to take a logical product of a clock signal P2 and a clock enable signal P3, a data fetching section 34 to fetch an output signal of the logic gate 34a and an image signal P1, an RGB-to-YC conversion section 34d to perform a predetermined digital-signal processing on the image signal and generate an image data, and a clock control section 34c to take clock control of the RGB-to-YC conversion section 34d in the timing the data fetch section 34b completes the fetching of data. The RGB-to-YC conversion section 34d is to perform a digital signal processing, including linear-matrix correction, white-balance adjustment, gamma correction, synchronization and Y/C conversion. The image signal P1, shown in FIG. 3, has been signal-processed in the AFE 12. The clock signals P2, P3 shown in FIG. 3 are supplied from the timing generator 16.

The clock signal P2 and clock enable signal P3, inputted from the timing generator 16, is inputted as a logic-product clock signal to the data fetch section 34b. Simultaneously, the image signal P1, inputted from the timing generator 16, is inputted as a fetched-data signal to the data fetch section 34b. The image signal, taken in by the data fetch section 34b, is stored in the memory 20.

The output clock of the clock generator 32 is controlled, by the clock control section 34c, in the timing the data fetch section 34b completes the fetching of data and the RGB-to-YC conversion section 34d completes the processing of a signal, thus being inputted to the RGB-to-YC conversion section 34d.

The image compression/decompression block section 28, operating on the clock caused by the clock generator 32, performs a compression and decompression of the still image data stored in the memory 20. The display interface block 30, operating on the clock caused by the clock generator 32, performs a display processing to display the image data, stored in the memory 20, on a display or the like.

In the case a long-time exposure is done, no image signals are inputted to the data fetch section 34b in a time nearly equal to a prolonged exposure period from a completion of fetching of a first image signal by the data fetch section 34b. Consequently, when performed a long-time exposure, the timing generator 16 controls the data fetch section 34 to suspend from operating in a third period of from a completion of fetching of the first image signal up to a time a second image signal is started transferred from the timing generator 16 and allowed to be fetched.

For example, the data fetch section 34b, when completed the fetching of the first image signal, inputs a signal representative of the relevant fact to the timing generator 16. Inputted with the signal, the timing generator 16 makes the clock enable signal P3 low in level so that output of a clock P2 to the data fetch section 34b is disabled. This suspends the data fetch section 34b from operating. The timing generator 16, when to supply the second image signal to the data fetch section 34b, makes the clock enable signal P3 high in level so that output of a clock P2 to the data fetch section 34b is enabled. This allows the data fetch section 34b to operate. In this manner, the timing generator 16 takes an operation control of the data fetch section 34b.

Incidentally, the timing generator 16 must not suspend the data fetch section 34b from operating over the entire of a third period. It is satisfactory to control the clock enable signal P3 in a manner allowing a period at least to exist suspending the data fetch section 34b from operating in the relevant period.

Meanwhile, in the case a long-time exposure is done, there is a need to wait a time of the prolonged exposure before the data fetch section 34b completes the fetching of the second image signal after the RGB-to-YC conversion section 34d completes the signal processing of the first image signal. Accordingly, the RGB-to-YC conversion section 34d must not be operated in that duration. Therefore, in the case a long-time exposure is done, the clock control section 34c controls the RGB-to-YC conversion section 34d to suspend from operating in a fourth period of from a completion of signal processing of the first image signal up to a time that signal processing is allowed for the second image signal completely fetched by the data fetch section 34b.

In this embodiment, in the case a long-time exposure is done, the data fetch section 34b, in a time completed the fetching of the first image signal, inputs a signal TE representative of the relevant fact to the clock control section 34c. Inputted with the signal TE, the clock control section 34c supplies the clock supplied from the clock generator 32 directly to the RGB-YC conversion section 34d and causes the RGB-YC conversion section 34d to operate. The RGB-YC conversion section 34d, when performs a signal processing on the first image signal and completes the generation of image data, inputs a signal HE representative of the relevant fact to the clock control section 34c. Inputted with the signal HE, the clock control section 34c does not supply a clock, supplied from the clock generator 32, to the RGB-YC conversion section 34d. The clock control section 34c, when the data fetch section 34b completes the fetching of the second image signal, receives the signal TE and causes the RGB-YC conversion section 34d to operate. In this manner, the clock control section 34c takes an operation control of the RGB-YC conversion section 34d.

By supplying the image processing section 34 with a signal representative of whether or not a long-time exposure has been done, the image processing section 34 is allowed to perform the operation, noted above, only in the case a long-time exposure has been done.

In this manner, according to the solid-state imaging apparatus 1, in the case a long-time exposure has been done, operation is made as in the following. Namely, for the AFE 12, the data fetch section 34b and the RGB-to-YC conversion section 34d that are signal processing units for different signal processing, in order, on the image signal outputted from the solid-state imaging element 10, operation can be suspended in the duration of from a completion of signal processing on a first image signal outputted from the solid-state imaging element 10 due to an exposure made immediately before the long-time exposure up to a time a signal processing can be started on a second signal obtained by the long-time exposure. This can reduce the consumption power.

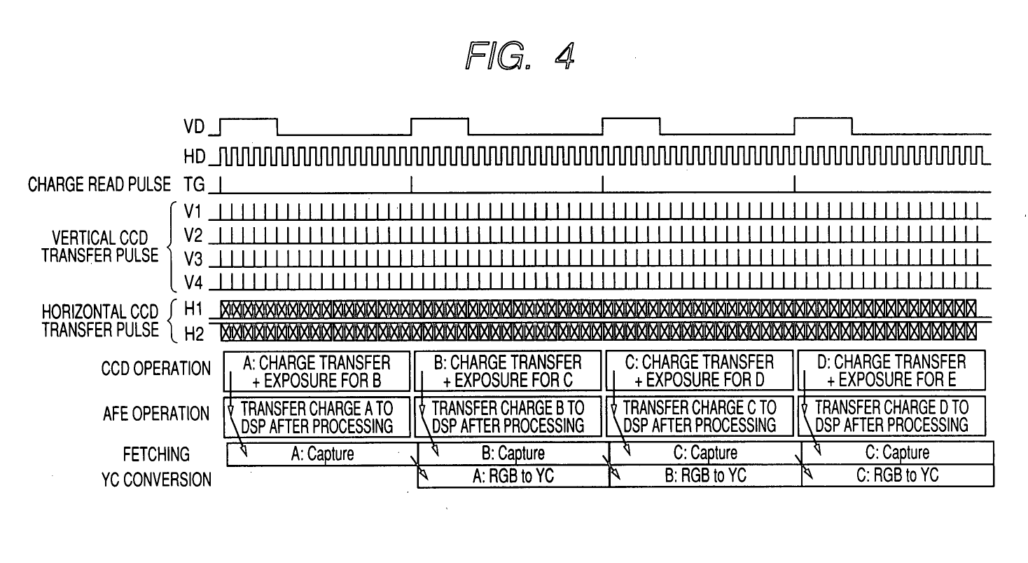

FIG. 4 is a timing chart showing the operation of the solid-state imaging apparatus according to the present embodiment, when displaying a through image or taking a moving image.

In FIG. 4, “CCD operation” represents a period that the CCD in the solid-state imaging device 10 is under transfer operation. “AFE operation” represents a period that the AFE 12 is under signal-processing operation. “Fetch process” represents a period that the data fetch section 34b is under image-signal fetch operation. “YC conversion process” represents a period that the RGB-to-YC conversion section 34d is under signal-rocessing operation. Meanwhile, in FIG. 4, the image signals successively outputted from the solid-state imaging element 10 as well the charges corresponding to the image signals are taken A-D in order.

As shown in FIG. 4, where there is no change in exposure period during displaying a through image or taking a moving image, the operations of CCD, AFE, fetch and YC-conversion are performed nearly uninterruptedly. In this case, the timing generator 16 and the clock control circuit 34c do not control the various sections to suspend from operating.

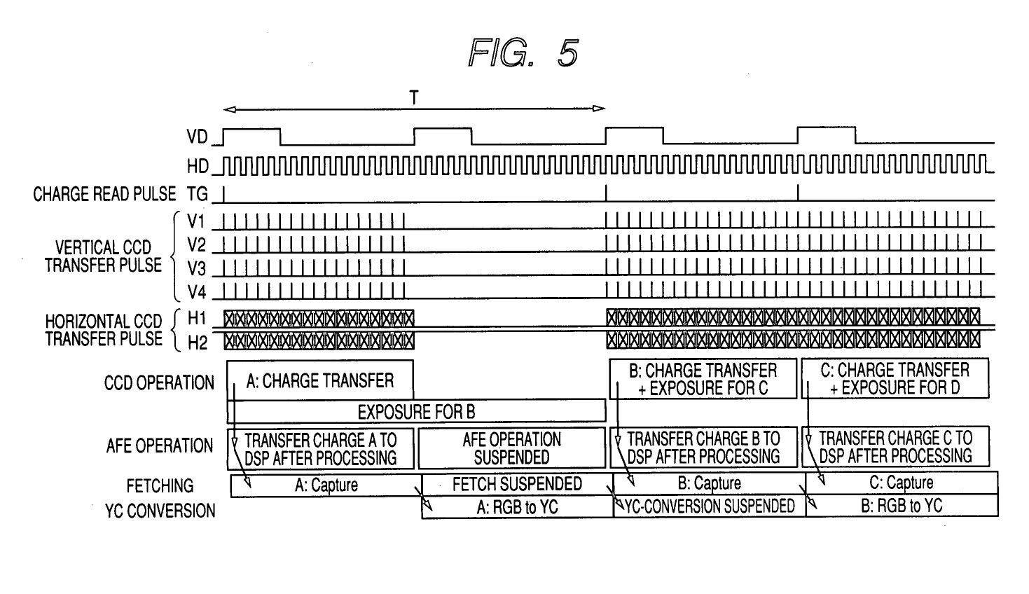

FIG. 5 is a timing chart showing the operation of the solid-state imaging apparatus according to the embodiment, when a long-time exposure is done during displaying a through image or taking a moving image.

In FIG. 5, “CCD operation” represents a period that the CCD in the solid-state imaging device 10 is under transfer operation. “AFE operation” represents a period that the AFE 12 is under signal-processing operation. “Fetch process” represents a period that the data fetch section 34b is under image-signal-fetch operation. “YC conversion process” represents a period that the RGB-to-YC conversion section 34d is under signal-processing operation. Meanwhile, in FIG. 5, the image signals successively outputted from the solid-state imaging element 10 as well the charges corresponding to the image signals are taken A-D in order. In the FIG. 5 example, the period shown at T in the figure is a duration that a long-time exposure is being done. Meanwhile, the foregoing first signal corresponding to symbol A while the second image signal to symbol B.

As shown in FIG. 5, transfer is made of the charge A obtained in an exposure period immediately before performing a long-time exposure. In a duration of a completion of outputting the corresponding image signal A out of the output amplifier 46 up to a completion of a long-time exposure, the supply of pulses V1-V4, H1 and H2 are ceased, thus suspending the CCD from operating. Meanwhile, the AFE 12 is suspended from operating in a duration of from a completion of signal processing of the image signal A up to a time an image signal B is started outputted from the solid-state imaging device 10. Meanwhile, the data fetch section 34b is suspended from operating in a duration of from a completion of fetching of the image signal A up to a time the image signal B is started transferred from the timing generator 16. The RGB-to-YC conversion section 34d is suspended from operating in a duration of from a completion of signal processing of the image signal A up to a completion of fetching of the image signal B.

In this manner, in the case a long-time exposure is done on the solid-state imaging apparatus 1, consumption power can be reduced because the CCD, AFE 12, data fetch section 34b and RGB-to-YC conversion section 34d is suspended from operating uselessly as done in the related art.

Incidentally, although the above explained to suspend the CCD, AFE 12, data fetch section 34b and RGB-to-YC conversion section 34d from operating upon performing a long-time exposure, the CCD must not be suspended from operating. Because there are included many circuits greater in power consumption in the AFE 12, the data fetch section 34b and the RGB-to-YC conversion section 34d, power consumption can be sufficiently reduced by merely suspending those. Meanwhile, consumption power can be sufficiently reduced by merely suspending one of the AFE 12, the data fetch section 34b and the RGB-to-YC conversion section 34d from operating.

Although the above explained provided the timing generator 16 and the analog front end 12 in the separate chips, the invention is applicable to the case where they are configured on one chip.

The present invention can provide a solid-state imaging apparatus capable of reducing the consumption power.

The entire disclosure of each and every foreign patent application from which the benefit of foreign priority has been claimed in the present application is incorporated herein by reference, as if fully set forth.

What is claimed is:

1. A solid-state imaging apparatus comprising:
(i) a solid-state imaging device comprising:
a plurality of photoelectric conversion elements;
a vertical transfer section that vertically transfers a signal charge stored on the photoelectric conversion elements;
a horizontal transfer section that horizontally transfers the signal charge transferred the vertical transfer section; and
an output amplifier that outputs an image signal commensurate with the signal charge transferred the horizontal transfer section; and
(ii) an image-data generating section that generates image data from the image signal,
wherein the image-data generating section comprises a plurality of signal processing units that perform different signal processes, in order, on the image signal, and
wherein the solid-state imaging apparatus further comprises a signal-processing-unit-operation control section that, in an operation mode to successively outputting image signals from the solid-state imaging device and in a case performed a long-time exposure wherein an exposure period for obtaining a second image signal next to a first image signal continues a predetermined time even after a completion of outputting of the first image signal from the solid-state imaging device, performs control of providing a period for which at least one of said plurality of signal processing units is suspended from operating in a duration of from a completion of signal processing on the first image signal up to a time for starting a signal processing on the second image signal.

2. A solid-state imaging apparatus according to claim 1, further comprising
a transfer control section that, in the long-time exposure, performs control of providing a period for which the vertical and horizontal transfer sections are suspended from transfer-operating in a duration of from a completion of outputting the first image signal from the output amplifier up to a termination of an exposure period for obtaining the second image signal.
